(19) United States
(12) Patent Application Publication
(10) Pub. No.: US 2005/0242207 A1
(43) Pub. Date: Nov. 3, 2005

(54) Spray gun coupled with a quick connect ring nut and a spring-loaded air diverter and a method for assembling the same

(76) Inventor: Ramon Tejeda, Mundelein, IL (US)

Correspondence Address: PATENTS+TMS, P.C., 2849 W. ARMITAGE AVE., CHICAGO, IL, 60647, US

(21) Appl. No.: 10/837,721

(22) Filed: May 3, 2004

(51) Int. Cl. B05B 1/30

(52) U.S. Cl. 239/346; 239/338; 239/290; 239/296; 239/583

(57) ABSTRACT

A high-volume, low-pressure(HVLP) spray gun coupled with quick connect ring nut and a spring-loaded air diverter and a method for assembling the same applies, for example, non-latex paints, such as, for example, automobile paints, thinner-based paints and/or the like to surfaces. A barrel attaches to a body of the spray gun which has an air cap attached to a ring nut with a retaining ring and the spring-loaded air diverter. The air diverter then abuts the air cap. The diverter has intermediate channels therein. A trigger engages a two-stage air bypass valve which allows air from an air source to move through a bypass channel, a top channel and/or diverter channels to exit through a pair of diverter orifices and an opening in the air cap. The air atomizes the paint in a nozzle channel of the gun and exits the opening in a conically diverging spray pattern. The air from the diverter orifices forces the diverging spray pattern into a different spray pattern.

### BACKGROUND OF THE INVENTION

The present invention generally relates to a spray gun used to apply paint to surfaces. More specifically, the present invention relates to a high-volume, low-pressure (hereinafter “HVLP”) spray gun coupled with a spring-loaded air diverter and a method for assembling the same. The HLVP spray gun may be used to apply paints, particularly, for example, latex paints, such as, automobile paints, thinner-based paints and/or the like to surfaces. Further, the HLVP spray gun may have a barrel attached to a body which may receive air from an air source and/or paint from a paint source. The barrel may have an air cap attached to a ring nut. The quick connect ring nut and the spring-loaded air diverter have a retaining ring such that the air diverter may abut the air cap. The barrel may receive a liquid nozzle which may be attached to a shaft, such as, for example, a liquid needle pin and/or a two-stage air bypass valve. Still further, the HVLP spray gun may have a trigger and/or a top channel which may be adjacent to the two-stage air bypass valve and/or the spring-loaded air diverter. The trigger may be engaged by, for example, an eighth of an inch of linear movement in the first stage which may allow air to flow through the channels of the spray gun body and/or the openings in the air cap. Moreover, the trigger may be engaged beyond, for example, an eight of an inch in the second stage which may engage the liquid need pin. As a result, the liquid needle pin may allow the air from the air source to force paint from the paint source through an opening in the liquid nozzle.

It is generally known that painters use a spray gun to paint surfaces, such as, for example, a body of an automobile. However, conventional spray guns use pressurized air to force the paint from the spray guns and/or onto the surfaces. The pressurized air used to force the paint from the spray gun often causes the paint to strike the surface and bounce off of the surface, resulting in splatter and/or paint drippings. A transfer efficiency of a spray gun is a ratio of the amount of paint applied to the surface in comparison to the amount of paint which bounces from the surface. Conventional spray guns have a low transfer efficiency which results in paint waste and/or an increase in pollution caused by the paint waste.

In an effort to minimize pollution caused by paint waste and/or spray guns, some states, such as, for example, California, have enacted legislation restricting the use of conventional spray guns. Under California regulations and United State Environmental Protection Agency's National Emission Standards for Hazardous Air Pollutants, the use of conventional spray guns is prohibited. And, the use of other spray guns, such as, for example, HVLP spray guns must have an atomizing air pressure not exceeding ten pounds per square inch (hereinafter “psi”). The atomizing air pressure is the pressure of the air which contacts the paint to atomize the paint outside the air cap. Further, HVLP spray guns have a high transfer efficiency which reduces the amount of paint bouncing from the surface along with resultant pollution caused thereby.

Traditionally, the nozzle configuration of a HVLP spray gun allows a air cap to move from open positions to closed positions without permitting the atomizing air pressure to exceed the ten psi requirement. However, the traditional HVLP spray gun merely has two open positions. Atomized paint generally is directed to exit from the spray gun in, for example, a conically diverging spray pattern. Additionally, the air cap has two side ports located at opposing positions which emit air inward at an angle against opposite sides of the conically diverging spray pattern. The air from the two side ports forces the conically diverging spray pattern of the atomized paint into a flat, fan-shaped spray pattern. Further, moving the air cap from an open position to an adjacent open position changes the angle of the flat, fan-shaped spray pattern by forty-five degrees. However, HVLP spray guns are difficult to assemble and are expensive to maintain due to corrosion and/or deterioration.

A need, therefore, exists for a spray gun coupled with a quick connect ring nut and a spring-loaded air diverter and a method for assembling the same. Additionally, a need exists for a spray gun coupled with a quick connect ring nut and a spring-loaded air diverter and a method for assembling the same which may resist corrosion and/or deterioration caused from chemicals, such as, for example, paint. Further, a need exists for a spray gun coupled with a quick connect ring nut and a spring-loaded air diverter and a method for assembling the same which may comply with state and federal regulatory laws. Still further, a need exists for a spray gun coupled with a quick connect ring nut and a spring-loaded air diverter and a method for assembling the same which may provide additional open positions in the air cap to accurately rotate the spray pattern by additional angles. Moreover, a need exists for a spray gun coupled with a quick connect ring nut and a spring-loaded air diverter and a method for assembling the same which may allow easy replacement of the air cap by removing a retaining ring. Furthermore, a need exists for a spray gun coupled with a quick connect ring nut and a spring-loaded air diverter and a method for assembling the same which may allow easy assembly and/or disassembly of a heat isolator tube via a spring-loaded air intake plug.

### SUMMARY OF THE INVENTION

The present invention relates to a high-volume low-pressure (HVLP) spray gun coupled with a quick connect ring nut and a spring-loaded air diverter and a method for assembling the same. The HVLP spray gun may be used to apply, for example, paints, particularly non-latex paints, such as, for example, automobile paints, thinner-based paints and/or the like to surfaces. Further, the HVLP spray gun may have a barrel attached to a body which may receive and/or may emit air from an air source and/or paint from a paint source. The barrel may have an air cap attached to a ring nut with a retaining ring and/or the spring-loaded air diverter such that the air diverter abuts the air cap. The spring-loaded air diverter may have a plurality of intermediate channels therein. Moreover, the barrel may receive a liquid nozzle which may be attached to a liquid needle pin having a two-stage air bypass valve.

The spray gun may have a trigger and/or a top channel which may be adjacent to a bypass channel and/or the two-stage air bypass valve and/or may be coupled to the spring-loaded air diverter. The top channel and/or the bypass channel may be spring-loaded. The trigger may be engaged to open the air bypass value and/or to allow the air from air source to force paint from the paint source along the liquid nozzle and/or through an opening in the air cap. Further, the air may exit the barrel through the opening coupled to the liquid nozzle and/or a pair of diverter orifices in the air cap aligned with a pair of opposing diverter channels in the air diverter. Still further, the air may atomize the paint from the paint source and/or may force the paint through the opening of the air cap in, for example, a conically diverging atomizing spray pattern with an air pressure of, for example, less than ten psi. The pair of diverter channels and/or a pair of diverter orifices may be positioned in an open position which may allow the air in a plurality of intermediate channels to exit through the diverter orifices to force the conically diverging spray pattern into a flat, fan-shaped spray pattern.

To this end, in an embodiment of the present invention, spray gun receiving air from an air source and paint from a paint source is provided. The spray gun has a first channel having a first end and a second end opposite to the first end wherein the first channel connects to the air source and further wherein a valve abuts the first end of the first channel. Further, the spray gun has a top channel having a first end and a second end opposite to the first end wherein the top channel is connected to the interior of the first channel and the paint source and further wherein the second end of the top channel is adjacent to the first channel. Still further, the spray gun has a nozzle having a passage defined between a first end and a second end wherein the passage connects to the first end of the top channel and the paint source wherein the second end of the nozzle is adjacent to the first end of the top channel, Moreover, the spray gun has a first spring between the valve and the second end of the first channel.

In an embodiment, the spray gun has a second spring between the first end of the top channel and the second end of the top channel.

In an embodiment, the spray gun has a second spring between the first channel and the air source.

In an embodiment, the spray gun has a second spring between the top channel and the paint source.

In an embodiment, the spray gun has a ball in the first channel.

In an embodiment, the spray gun has a ball in the top channel.

In an embodiment, the spray gun has a ball between the first channel and the air source.

In an embodiment, the spray gun has a ball between the top channel and the paint source.

In an embodiment, the spray gun has a ball between the top channel and the nozzle.

In an embodiment, the spray gun has a tube between the air source and the first channel wherein the air from the air source passes through the tube into the first channel.

In an embodiment, the spray gun has a groove in the top channel wherein the groove is located between the first end and the second end of the top channel.

In an embodiment, the spray gun has a plurality of recessions between the first end and the second end of the nozzle.

In another embodiment of the present invention, a spray gun receiving air from an air source and paint from a paint source is provided. The spray gun has a barrel having a nozzle, a diverter and a cap connected to the diverter by a nut wherein the nozzle extends through the diverter and the cap and further wherein the nozzle is connected to the paint source. Further, the spray gun has a plurality of recessions on the diverter wherein the cap is adjacent to the plurality of recessions. Still further, the spray gun has a plurality of channels connecting the air source to the barrel wherein each of the plurality of channels have an interior and an exterior wherein the diverter of the barrel attaches to the plurality of channels and further wherein the air from the air source moves through the interior of each of the plurality of channels to the barrel. Moreover, the spray gun has a plurality of seals located between the interior and the exterior of each of the plurality of channels and further wherein each of the plurality of seals prevents the air in the interior of each of the plurality of channels from escaping to the exterior of each of the plurality of channels.

In an embodiment, the plurality of seals are chemically resistant.

In an embodiment, the plurality of seals are flourocarbon resins.

In an embodiment, each of the plurality of seals are adjacent to a corresponding one of each of the plurality of channels.

In another embodiment of the present invention, a method for assembling a spray gun coupled with a spring-loaded air diverter is provided. The method has the steps of providing a spray gun having a first channel, a second channel connected to the first channel and a trigger wherein the second channel has a passage defined between a first end and a second end and providing a diverter having a first end and a second end opposite to the first end wherein the diverter has an opening and a plurality of recessions around the opening wherein the opening extends through the diverter from the first end to the second end and further wherein the diverter has a first groove located between the first end and the second end. Further, the method has the step of attaching an engaging element to the second channel wherein the engaging element is adjacent to the second end of the second channel. Still further, the method has the step of inserting the diverter into the second channel wherein the first groove of the diverter receives the engaging element of the second channel. Moreover, the method has the step of attaching a cover to second channel wherein the cover has an exterior and an interior wherein encloses the diverter in the second channel and further wherein the cover has a second groove receiving the engaging element of the second channel.

In an embodiment, the method has the step of attaching a nut between the cover and the second channel.

In an embodiment, the second groove extends through the cover from the exterior to the interior.

In an embodiment, the engaging element is a ball.

In an embodiment, the method has the step of inserting a spring into the second channel.

In an embodiment, the method has the step of inserting a spring into the first channel.

In an embodiment, the method has the step of providing a ring between the cover and the diverter.

In an embodiment, the engaging element is a pin.

In an embodiment, the second groove is covered by the exterior of the cover.

In another embodiment of the present invention, a barrel for a spray gun is provided. The barrel has a channel having a first side and a second side opposite to the first side wherein the channel has an exterior and an interior. Further, the barrel has a diverter having a first end and a second end opposite to the first end wherein the diverter has a compartment defined by a perimeter wherein the compartment is centered within a plurality of channels wherein the compartment and the plurality of channels extend through the diverter from the first end to the second end. Still further, the barrel has a cap having a front side and a back side wherein the cap has an orifice and channels wherein the orifice and the channels extend through the cap from the front side to the back side and further wherein the orifice is between the channels. Moreover, the barrel has a nut having first side and a second side opposite the first side wherein the nut has an exterior and an interior wherein the nut connects the back side of the cap to the first side of the diverter wherein the second side of the diverter is adjacent to the second side of the nut and further wherein the nut has a first groove adjacent to the second side. Furthermore, the barrel has a engaging element extending from the exterior of the channel to the interior of the channel wherein the engaging element is adjacent to the second side of the channel and further wherein the first groove of the nut receives the engaging element wherein the nut is connected to the channel.

In an embodiment, the barrel has a spring between the first end of the diverter and the first side of the channel.

In an embodiment, the groove extends through the nut from the exterior of the nut to the interior of the nut.

In an embodiment, the groove is adjacent to the interior of the nut.

In an embodiment, the fastener is a ball.

In an embodiment, the fastener is a pin.

In an embodiment, the barrel has a ring between the back side of the cap and the first side of the diverter.

In an embodiment, the barrel has a plurality of recessions located on the first end of the diverter.

In an embodiment, the barrel has a plurality of balls on the back side of the cap.

In an embodiment, the engaging element of the channel connects the diverter to the channel.

In an embodiment, the barrel has a second groove adjacent to the first end of the diverter.

It is, therefore, an advantage of the present invention to provide a spray gun coupled with a quick connect ring nut and a spring-loaded air diverter and a method for assembling the same which requires no tools to assemble the spray gun.

Another advantage of the present invention is to provide a spray gun coupled with a quick connect ring nut and a spring-loaded air diverter and a method for assembling the same which allows an air cap of the spray gun to be easily replaced.

And, another advantage of the present invention is to provide a spray gun coupled with a quick connect ring nut and a spring-loaded air diverter and a method for assembling the same which requires no tools to replace the air cap of the spray gun.

Yet another advantage of the present invention is to provide a spray gun coupled with a quick connect ring and a spring-loaded air diverter and a method for assembling the same which provides a diverter in a nozzle which has eight index positions.

A further advantage of the present invention is to provide a spray gun coupled with a quick connect ring and a spring-loaded air diverter and a method for assembling the same which provides a nozzle having an air cap with four index balls for engaging sixteen rescissions in a diverter in the nozzle.

Moreover, an advantage of the present invention is to provide a spray gun coupled with a quick connect ring and a spring-loaded air diverter and a method for assembling the same which provides an air cap having four open positions wherein each adjacent open position rotate a spray pattern of the spray gun by forty-five degrees.

And, another advantage of the present invention is to provide a spray gun coupled with a quick connect ring and a spring-loaded air diverter and a method for assembling the same which provides TEFLON® seals therein to prevent deterioration from chemicals and/or paint.

Yet another advantage of the present invention is to provide a spray gun coupled with a quick connect ring and a spring-loaded air diverter and a method for assembling the same which provides stainless steel and/or chrome-plated balls therein to prevent corrosion.

Another advantage of the present invention is to provide a spray gun coupled with a quick connect ring and a spring-loaded air diverter and a method for assembling the same which provides one-eighth inch stainless steel and/or chrome-plated balls therein.

Yet another advantage of the present invention is to provide a spray gun coupled with a quick connect ring nut and a spring-loaded air diverter and a method for assembling the same which provides a retaining ring within the nozzle to retain an air cap to a ring nut.

A still further advantage of the present invention is to provide a spray gun coupled with a quick connect ring nut and a spring-loaded air diverter and a method for assembling the same which allows a retaining ring to popped out of a groove in a ring nut for easy removal of an air cap.

Moreover, an advantage of the present invention is to provide a spray gun coupled with a quick connect ring nut and a spring-loaded air diverter and a method for assembling the same which provides a passage from an air source to a top channel adjacent to the nozzle of the spray gun for atomizing paint from a paint source.

And, another advantage of the present invention is to provide a spray gun coupled with a quick connect ring nut and a spring-loaded air diverter and a method for assembling the same which allows a bypass channel, a top channel, an air source channel and/or a paint source channel to be spring-loaded.

Yet another advantage of the present invention is to provide a spray gun coupled with a quick connect ring and a spring-loaded air diverter and a method for assembling the same which allows easy assembly and/or disassembly of a Teflon® tube heat isolator via a spring-loaded air intake plug.

Another advantage of the present invention is to provide a spray gun coupled with a quick connect ring and a spring-loaded air diverter and a method for assembling the same which provides a Teflon® tube to isolate the handle of the spray gun from the hot air generated by the air source.

Yet another advantage of the present invention is to provide a spray gun coupled with a quick connect ring nut and a spring-loaded air diverter and a method for assembling the same which provides a method to seal the air intake side with a Teflon® tube.

A still further advantage of the present invention is to provide a spray gun coupled with a quick connect ring nut and a spring-loaded air diverter and a method for assembling the same which provides easy assembly and/or disassembly of a liquid needle pin assembly and/or a two-stage air bypass valve via a spring-loaded air bypass plug.

Moreover, an advantage of the present invention is to provide a spray gun coupled with a quick connect ring nut and a spring-loaded air diverter and a method for assembling the same which provides a one-piece construction of a two-stage bypass valve and/or a liquid needle pin activating mechanism.

And, another advantage of the present invention is to provide a spray gun coupled with a quick connect ring nut and a spring-loaded air diverter and a method for assembling the same which provides a one-piece component having sealing surfaces to prevent air from entering the spray gun channels until activated and/or sealing surfaces to prevent air from escaping the spray gun body.

Yet another advantage of the present invention is to provide a spray gun coupled with a quick connect ring and a spring-loaded air diverter and a method for assembling the same which allows channeling of air within the spray gun body without drilling connection holes between channels and/or without making a multi-piece gun body construction.

Another advantage of the present invention is to provide a spray gun coupled with a quick connect ring and a spring-loaded air diverter and a method for assembling the same which provides easy assembly and/or disassembly of a spray fan size pattern metering assembly via a spring loaded top channel plug.

Yet another advantage of the present invention is to provide a spray gun coupled with a quick connect ring nut and a spring-loaded air diverter and a method for assembling the same which provides a metering of air entering the spray gun channels in a full-flow position, a half-flow position and/or a quarter-flow position.

A still further advantage of the present invention is to provide a spray gun coupled with a quick connect ring nut and a spring-loaded air diverter and a method for assembling the same which provides a Teflon® tube to channel the paint into the liquid nozzle and/or an air tight seal at the paint source.

Moreover, an advantage of the present invention is to provide a spray gun coupled with a quick connect ring nut and a spring-loaded air diverter and a method for assembling the same which allows easy assembly and/or disassembly of a paint source Teflon® tube assembly via a spring-loaded paint intake plug.

And, another advantage of the present invention is to provide a spray gun coupled with a quick connect ring nut and a spring-loaded air diverter and a method for assembling the same which provides a method for keeping an air diverter in place and/or disassembling the air diverter.

Yet another advantage of the present invention is to provide a spray gun coupled with a quick connect ring and a spring-loaded air diverter and a method for assembling the same which provides a method of controlling a size of a cone shape of a spray pattern.

Additional features and advantages of the present invention are described in, and will be apparent from, the detailed description of the presently preferred embodiments and from the drawings.

### BRIEF DESCRIPTION OF THE DRAWINGS

FIG. 1 illustrates a cross-sectional view of a spray gun coupled with a quick connect ring nut and a spring-loaded air diverter, a paint source and an air source in an embodiment of the present invention.

FIG. 2 illustrates a cross-sectional view of the quick connect ring nut and the spring-loaded air diverter in FIG. 1 in an embodiment of the present invention.

FIG. 3 illustrates a cross-sectional view of a top channel coupled to a bypass channel in FIG. 1 in an embodiment of the present invention.

FIG. 4 illustrates a cross-sectional view of an air source channel connected to the air source in FIG. 1 in an embodiment of the present invention.

FIG. 5 illustrates a cross-sectional view of a paint source channel connected to the paint source in FIG. 1 in an embodiment of the present invention.

FIG. 6 illustrates a perspective view in partial cross-section of an air cap and a diverter in an embodiment of the present invention.

FIG. 7 illustrates a front plan view of a diverter and a liquid nozzle in an embodiment of the present invention.

FIG. 8 illustrates a front plan view of a diverter and a liquid nozzle in an embodiment of the present invention.

### DETAILED DESCRIPTION OF THE PRESENTLY PREFERRED EMBODIMENTS

The present invention relates to a high-volume, low-pressure (HVLP) spray gun coupled with a quick connect ring nut and a spring-loaded air diverter and a method for assembling the same. Further, the spray gun may be used to apply, for example, paints, particularly non-latex paints, such as, for example, automobile paints, thinner-based paints and/or the like to surfaces. The HVLP spray gun may have a barrel attached to a body. The barrel may have an air cap attached to a ring nut with a retaining ring and/or the spring-loaded air diverter such that the air diverter abuts the air cap. Still further, the spring-loaded air diverter may have a plurality of intermediate channels therein. A trigger may engage a two-stage air bypass valve which may allow air from an air source to enter the spray gun and/or to exit through a pair of diverter orifices and/or an opening in the air cap. Moreover, paint exiting a nozzle channel of the gun may be atomized outside the air cap and may exit the opening in, for example, a conically diverging spray pattern. Furthermore, the conically diverging spray pattern may be forced into a flat fan-shaped spray pattern from the air that may exit the pair of diverter orifices in the air cap.

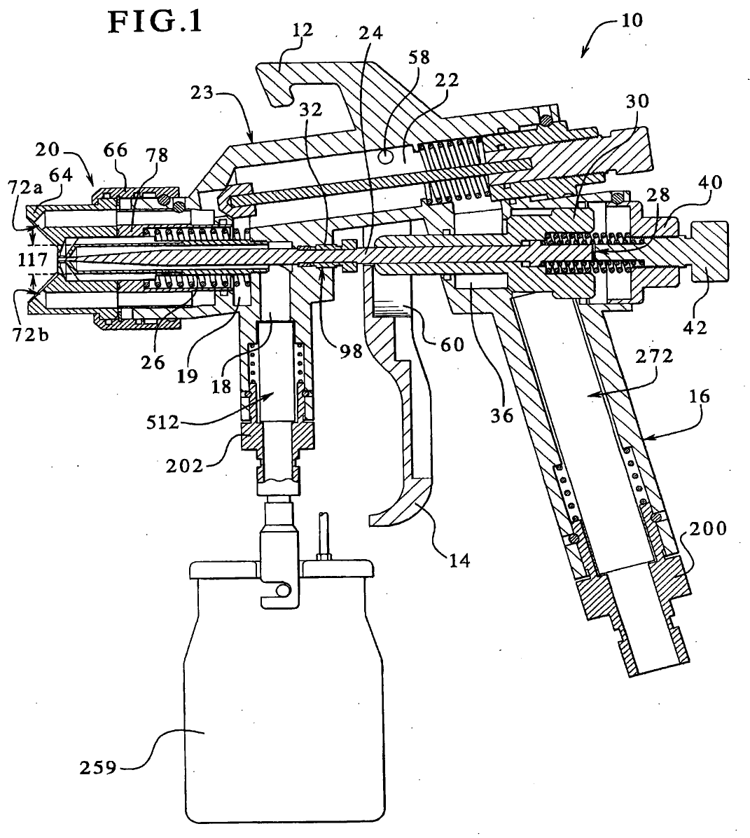

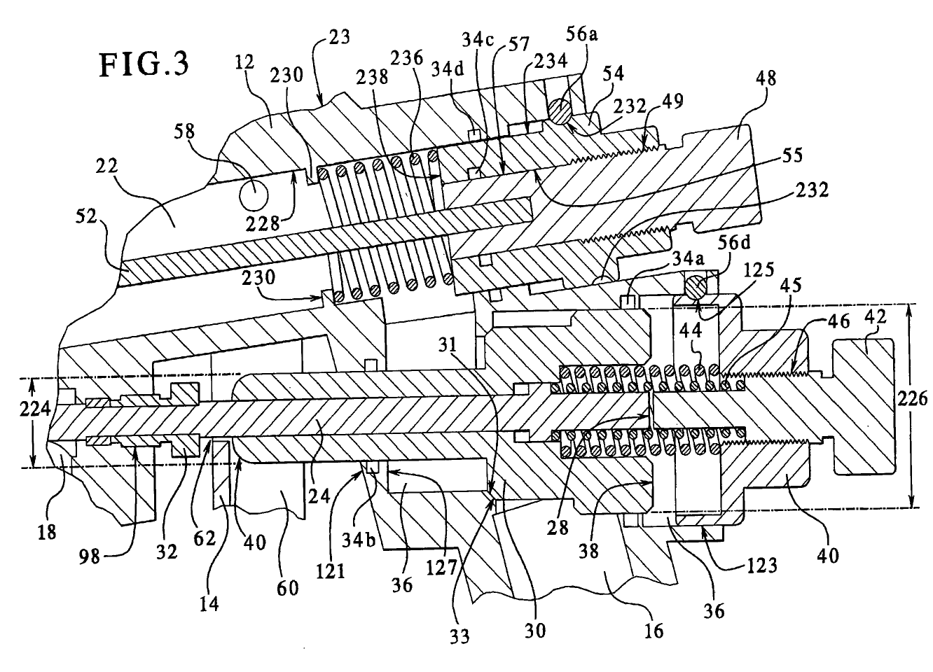

Referring now to the drawings wherein like numerals refer to like parts, FIGS. 1-5 illustrate a cross-sectional view of a HVLP spray gun 10 (hereinafter “spray gun 10”) coupled with a quick connect ring nut and a spring-loaded air diverter in an embodiment of the present invention. The spray gun 10 may have a hanger 12 and/or a trigger 14. The hanger 12 may allow the spray gun 10 to be hung from, for example, a peg on a peg board during storage. The trigger 14 may allow a user to activate and/or deactivate the spray gun 10. Further, the spray gun 10 may receive air from an air source (not shown in the drawings) via an air source connector 200 and/or an air source channel 16. Still further, the spray gun 10 may receive paint from a paint source 259 via a paint source connector 202 a paint source channel 18. The air source may be, for example, a conventional compressed air system, an air turbine system and/or the like. The air source may provide air to the spray gun 10 at an air pressure, such as, for example, one hundred pounds per square inch (hereinafter “psi”).

The paint supplied to the spray gun 10 by the paint source 259 may be, for example, paint, particularly non-latex paint, such as, for example, an automobile paint, a thinner-based paint and/or the like. The air source channel 16 and/or the paint source channel 18 may be spring-loaded. The spray gun 10, the hanger 12 and/or the trigger 14 may be made from a material, such as, for example, steel, aluminum, plastic and/or the like. Moreover, the present invention should not be deemed as limited to a specific air source, a specific air pressure of the air source, a specific paint and/or a specific material of the spray gun 10, the hanger 12 and/or the trigger 14.

The spray gun 10 may have a barrel 20 adjacent to a barrel channel 19. The barrel channel 19 may be adjacent to the paint source channel 18 and/or a top channel 22. The paint source channel 18 may be adjacent to the paint source connector 202. The top channel 22 may be adjacent to the barrel 20, the barrel channel 19 and/or a bypass channel 36. The bypass channel 36 may be adjacent to the top channel 22, a liquid needle pin 24 and/or the air source connector 200. The top channel 22 and/or the bypass channel 36 may be spring-loaded. The liquid needle pin 24 may have a liquid nozzle 26 and/or a bypass end 28 opposite the liquid nozzle 26. The liquid needle pin 24 may be, for example, a liquid needle and/or may regulated the amount of paint entering the liquid nozzle 26. Further, the liquid needle pin 24 may have an two-stage air bypass valve 30 attached to the bypass end 28 and/or a housing 32 located at a point between the two-stage air bypass valve 30 and the liquid nozzle 26. Still further, the two-stage air bypass valve 30 may have a chamfer 31 adjacent to the air source channel 16. Moreover, the bypass channel 36 may have a surface 33 which may abut the chamfer 31 of the two-stage air bypass valve 30. Furthermore, the chamfer 31 and/or the surface 33 may be at an angle, such as, for example, forty-five degrees with respect to the liquid needle pin 24.

The bypass end 28 may be connected to a bypass plug 40 and/or a bypass nob 42 with a control spring 45. Further, the bypass nob 42 may be, for example, a liquid meter screw. The bypass plug 40 and the bypass nob 42 may be connected by a threading 46. The threading 46 may allow the bypass nob 42 to be turned, for example, clockwise or counter-clockwise for adjusting an amount of force which may be exerted on the two-stage air bypass valve 30 by the control spring 45. The force exerted by the control spring 44 may control the amount of air allowed to enter the bypass channel 36 and/or may correspond to a force required to activate the trigger 14. Further, the force of the control spring 45 may correspond to a force required to shut off a liquid passage between the paint source 259 and the liquid nozzle 26. The barrel 20, the paint source channel 18, the air source channel 16, the top channel 22, the bypass channel 36, the liquid needle pin 24, the liquid nozzle 26, the bypass end 28, the housing 32, the bypass plug 40, the bypass nob 42 and/or the bypass spring 44 may each have, for example, a cylindrical shape allowing each to be connected to one another and/or to be displaced within each other.

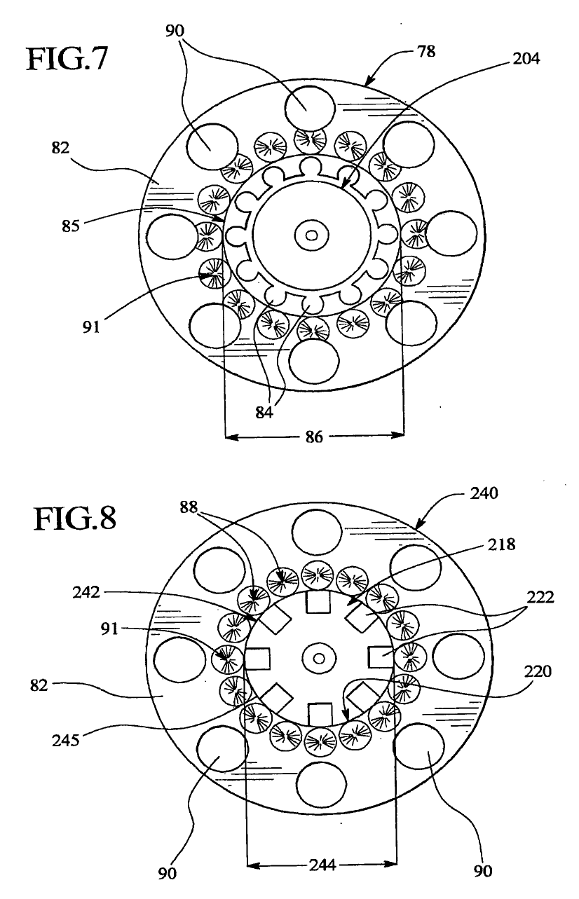

The liquid nozzle 26 may have a length 27 and/or a perimeter 204 (as shown in FIGS. 7 and 8). Further, the liquid nozzle 26 may have a front end 206 and/or a back end 208. The back end 208 may be opposite the front end 206. Still further, the liquid nozzle 26 may have an interior 210 and an exterior 212. Threading 214 may be located on the exterior 212 of the back end 208 of the liquid nozzle 26 to an interior 218 of the barrel channel 19 and/or may attach the liquid nozzle 26 to the barrel channel 19. Moreover, the interior 210 of the liquid nozzle 26 may receive the liquid needle pin 24 therein.

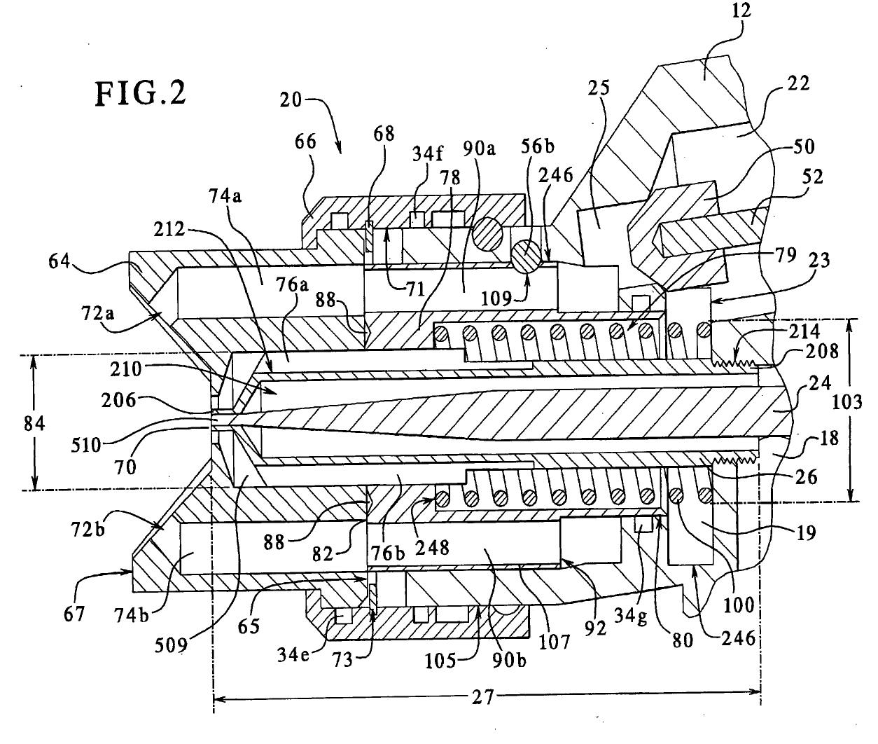

FIG. 8 illustrates an alternate embodiment of a liquid nozzle 218 which may have the length 27 (as seen in FIG. 2) and/or a perimeter 220 which has a plurality of indentations 222. The plurality of indentations 222 may extend along the length 27 of the liquid nozzle 218. Further, the plurality of indentations 222 may be a number of indentations, such as, for example, eight indentations. Each of the plurality of indentations 222 may be, for example, a rectangular shape and/or may be separated from each other by an angle, such as, for example, forty-five degrees. Moreover, it should be understood that the plurality of indentations 222 may be any number of indentations and/or may be separated by any angle that may be implemented by one having ordinary skill in the art. Furthermore, the present invention should not be deemed as limited to the embodiments of a specific shape of the plurality of indentations 222 of the liquid nozzle 26.

The two-stage air bypass valve 30 may have a first end 38 adjacent to the bypass end 28 and/or a second end 40. The second end 40 may be opposite to the first end 38. Further, the second end 40 may have a diameter 224 which is less than a diameter 226 of the first end 38. A bypass spring 44 may be located between the first end 38 of the two-stage air bypass valve 30 and the bypass plug 40. Still further, the two-stage air bypass valve 30 may have a seal 34a located adjacent to the first end 38 and/or may have a seal 34b located at a point between the first end 38 and the second end 40. The first end 38 and/or the second end 40 may be, for example, a cylindrical shape which may allow the two-stage air bypass valve 30 to be inserted into the bypass channel 36 and/or to be displaced within the bypass channel 36.

The top channel 22 may have a top channel plug 54 and/or a top channel nob 48. The top channel 22 may have a first opening 23 and/or a second opening 25. The first opening 23 of the top channel 22 may be coupled to the barrel channel 19. The top channel nob 48 may be connected to a stopper 50 with a top channel shaft 52. The stopper 50 may close the second opening 25. The top channel 22 may be adjacent to the bypass channel 36 and/or may be coupled to the bypass channel 36. The top channel plug 54 and the top channel nob 48 may be connected by a top threading 49. The top threading 49 may allow the channel nob 48 to be turned, for example, clockwise or counter-clockwise for increasing a distance or decreasing the distance, respectively, between the stopper 50 and the top channel plug 54. Further, the top channel nob 48 may be inserted into the top channel plug 54. As a result, the top channel shaft 52 and/or the top channel nob 48 may extend outward with respect to the top channel plug 54. A seal 34c may be attached to an exterior 55 of the top channel nob 48. The seal 34c may then engage an interior 57 of the top channel plug 54. Still further, the seal 34c may secure the top channel nob 48 to the top channel plug 54. A seal 34d may be attached to an exterior 234 of the top channel plug 54. Accordingly, the seal 34d may engage the top channel 22. Moreover, the seal 34d may secure the top channel plug 54 to the top channel 22.

The top channel 22 may have an interior 228, a shoulder 230 located on the interior 228 and/or a fastener 56a located on the interior 228. The fastener 56a which may engages a groove 232 in the exterior 234 of the top channel plug 54 to lock the top channel plug 54 into the top channel 22. A top channel spring 236 may be located between the shoulder 230 and a first end 238 of the top channel plug 54. Further, the top channel spring 236 may be compressed by locking the top channel plug 54 into the interior 228 of the top channel 22. Releasing the fastener 56a on the interior 228 of the top channel 22 from the groove 232 in the exterior 234 of the top channel plug 54 may unlock the top channel plug 54 from the interior 232 of the top channel 22. Unlocking the top channel plug 54 from the interior 232 may decompress the top channel spring 236 and/or may force the top channel plug 54 in an outward direction with respect to the interior 232 of the top channel 22.

The groove 232 may spiral along the exterior 234 of the top channel plug 54. As a result, the top channel plug 54 may move in an inward direction or an outward direction with respect to the interior 228 of the top channel 22 and/or may isolate the top channel 22 from the bypass channel 36. The fastener 56 may be, such as, for example, a pin, a ball and/or the like. Further, the fastener 56 may be made from a corrosion resistant material, such as, for example, chrome, stainless steel and/or the like. Still further, the interior 228 of the top channel 22, the shoulder 230, the exterior 234 of the top channel plug 54, the top channel spring 236, the top channel nob 48, the stopper 50, the top channel shaft 52 and/or the top channel plug 54 may each have, for example, a cylindrical shape to allow each to be displaced within the top channel 22.

The trigger 14 may attach to the exterior of the spray gun 10. Further, the trigger 14 may have a pair of arms (not shown) which extend around an exterior 23 of the top channel 22 of the spray gun 10. Each arm of the trigger may extend to an opposite side of the exterior 23 of the top channel 22 of the spray gun 10. A trigger mount 58 may extend through the top channel 22 and/or may be connected to the arms of the trigger 14. The trigger mount 58 may allow the trigger 14 to move an angular distance between the paint source channel 18 and the air source channel 16. Still further, the trigger 14 may have a cavity 60 adjacent to the exterior 23 of the top channel 22. The cavity 60 may have a passage 62 which allows the liquid needle pin 24 to pass therethrough from the bypass channel 36 to the barrel channel 19 and/or the barrel 20. The cavity 60 may be a shape, such as, for example, a rectangle, a square and/or the like. The trigger mount 58 may be, for example, a bolt and a nut, a pin and a clip, a peg and/or the like. Moreover, it should be understood that the trigger mount 58 may be any known trigger mount that may be implemented by one having ordinary skill in the art.

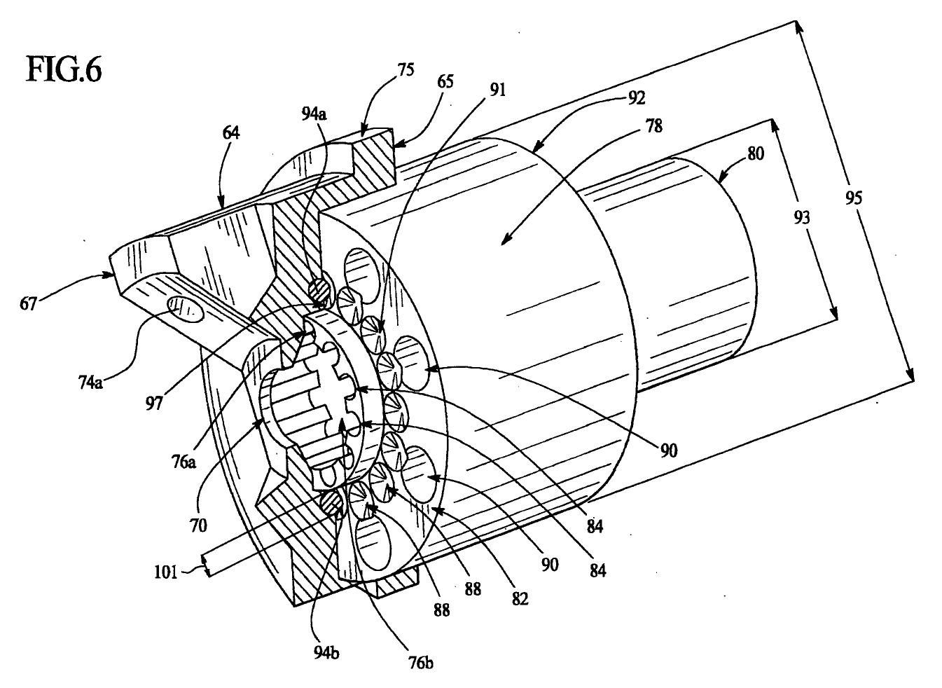

As illustrated in FIGS. 1, 2 and 6, the barrel 20 may have an air cap 64 connected to a ring nut 66 having a retaining ring 68. The air cap 64 may have a first end 65 and/or a second end 67 that is opposite the first end 65. The first end 65 may have a nozzle compartment 76a and/or may be adjacent to the retaining ring 68 and/or the ring nut 66. The second end 67 may have an opening 70. Further, the second end 67 may have a pair of diverter orifices 72a, 72b coupled to diverter channels 74a, 74b, respectively. The opening 70 of the air cap 64 may be located between the pair of diverter orifices 72a, 72b and/or ay be coupled to the nozzle compartment 76a The opening 70 and/or the diverter orifices 72a, 72b coupled to diverter channels 74a, 74b, respectively, may permit, for example, air to move from the first side 65 of the air cap 64 to the second side 67 of the air cap 64 and/or through the opening 70 and/or the diverter orifices 72a, 72b, respectively. The diverter orifices 72a, 72b may be separated by, for example, one-hundred and eight degrees and may be angled inward toward the opening 70 of the air cap 64 at an angle, such as, for example, forty-five degrees.

The ring nut 66 may have an interior 71 which may have a groove 73 for receiving the retaining ring 68. The air cap 64 may be inserted into the interior 71 of the ring nut 68. The second end 67 of the air cap 64 may extend outward with respect to the ring nut 68 and/or the first end 65 of the air cap 64 may abut the interior 71 of the ring nut 66. Further, the seal 34e may be attached to an exterior 75 of the first end 65 of the air cap 64. As a result, the seal 34e may engage the interior 71 of the ring nut 66 and/or may secure the air cap 64 into the interior 71 of the ring nut 66. The retaining ring 68 may be inserted into the groove 73 in the interior 71 of the ring nut 66 and/or may retain the air cap 64 in the interior 71 of the ring nut 66. Still further, the retaining ring 66 may allow the air cap 64 to turn in an angular movement, such as, for example, clockwise or counter-clockwise. A force may be applied to the retaining ring 68 to remove the retaining ring 68 from the groove 73 in the interior 71 of the ring nut 66. For example, a flat end of a screwdriver may be inserted between the retaining ring 66 and the air cap 64. The flat end of the screwdriver may have a force applied thereto in a direction inward with respect to the retaining ring 68. As a result, the air cap 64 may be removed from the ring nut 66. The air cap 64, the ring nut 66, the retaining ring 68, the opening 70, the nozzle compartment 76a, diverter orifices 72a, 72b and/or diverter channels 74a, 74b may be, for example, a cylindrical shape to allow each to be connected and/or displaced within each other.

As illustrated in FIG. 7, the barrel 20 may have a diverter 78 which may have an input end 80, an output end 82 opposite to the input end 80 and/or a nozzle compartment 76b therein. The nozzle compartment 76b may extend through the diverter 78 from the input end 80 to the output end 82. Further, the nozzle compartment 76b may have a diameter 86. The nozzle compartment 76b may have a perimeter 85 with a plurality of notches 84 which may extend from the input end 80 to the output end 82. Still further, the plurality of notches 84 may be a number of notches, such as, for example, twelve notches. Each of the plurality of notches 84 may be separated from each other by an angle, such as, for example, thirty degrees. The diverter 78, the input end 80, the output end 82, the nozzle compartment 76b and/or each notch of the plurality of notches 84 may be, for example, a cylindrical shape. Moreover, the nozzle compartment 76b of the diverter 240 may be coupled with and/or may receive the liquid nozzle 26. Alternatively, FIG. 8 illustrates the diverter 240 having a nozzle compartment 242 with a diameter 244 and a perimeter 245. The nozzle compartment 242 may be coupled with and/or may receive the liquid nozzle 218.

As illustrated in FIGS. 1, 2, 6 and 7, the output end 82 of the diverter 78 and/or the diverter 240 may have a plurality of recessions 88 encircling the perimeter 85 and/or the perimeter 245, respectively, of the nozzle compartment 76b at the output end 82. Further, the plurality of recessions 88 may be a number of recessions 88, such as, for example, sixteen recessions which may be separated from each other by an angle, such as, for example, twenty-two and one-half degrees. Each of the plurality of recessions 88 may have a shape, such as, for example, a cone which may extend inward with respect to the output end 82 of the diverter 78 to a point 91.

The output end 82 of the diverter 78 may have a plurality of intermediate channels 90 encircling the plurality of recessions 88. The plurality of intermediate channels 90 may overlap the plurality of recessions 88. Each of the plurality of intermediate channels 90 may extend through the diverter 78 from the output end 82 to an intermediate end 92. The second opening 25 of the top channel 22 may be coupled to the plurality of intermediate channels 90. Further, the input end 80 may have a diameter 93 which may be greater than the diameter 86 of the nozzle compartment 76b and/or may be less than a diameter 95 of the output end 82 and/or of the intermediate end 92. Still further, the plurality of intermediate channels 90 may be a number of intermediate channels 90, such as, for example, eight intermediate channels. Each of the plurality of intermediate channels 90 may be separated from each other by an angle, such as, for example, forty-five degrees. Each of the plurality of intermediate channels 90 may be, for example, a cylindrical shape.

In another embodiment, FIG. 8 illustrates that the diverter 240 may have the plurality of recessions 88 encircling the perimeter 245. Further, the diverter 240 may have the plurality of intermediate channels 90 encircling the plurality of recessions 88. Moreover, the diverter 240 may allow the plurality of recessions 88 to be separated from the plurality of intermediate channels 90.

The first side 65 of the air cap 64 may have a plurality of index balls 94 which may encircle a perimeter 97 of the nozzle compartment 76a. The plurality of index balls 94 may be a number of index balls 94, such as, for example, four index balls 94. Further, the plurality of index balls 94 may be separated from each other by an angle, such as, for example, ninety degrees. Each of the plurality of index balls 94 may have a diameter 101, such as, for example, ninety-three hundredths (0.093) of an inch.

FIGS. 1 and 2 illustrates that the diverter 78 may be inserted into an interior 246 of the barrel channel 19. The interior 246 of the barrel channel 19 may have a fastener 56b. An exterior 107 of the diverter 78 may have a groove 109 which may receive the fastener 56b on the interior 246 of the barrel channel 19 and/or which may lock the diverter 78 into interior 246 of the barrel channel 19. Further, a diverter spring 100 may be located in a spring channel 79 of the diverter 78 and/or may be abutting a back side 248 of the plurality of notches 84 in the nozzle compartment 76b. The spring channel 79 and/or the spring 100 may have a diameter 103. The diameter 101 may be greater than the diameter 86 of the nozzle compartment 76b and/or less than the diameter 93 of the input end 80. Still further, the diverter spring 100 may be compressed by the diverter 78 locked into the interior 246 of the barrel channel 19. Releasing the fastener 56b of the interior 246 of the barrel channel 19 from the groove 109 in the exterior 107 of the diverter 78 may unlock the diverter 78 from the interior 246 of the barrel channel 19. Unlocking the diverter 78 from the interior 246 may decompress the diverter spring 100 and/or may force the diverter 78 outward with respect to the interior 246 of the barrel channel 19.

The barrel channel 19 may have an exterior 105 with a fastener 56c. The interior 71 of the ring nut 66 may have a groove 113. The groove 113 may receive the fastener 56c on the exterior 105 of the barrel channel 19 and/or may lock the exterior 105 of the barrel channel 19 into the interior 71 of the ring nut 66. Further, the groove 113 may spiral around the interior 71 of the ring nut 66. As a result, the ring nut 66 and/or the air cap 64 may move in an inward direction or an outward direction with respect to the barrel channel 19, the liquid needle pin 24 and/or the liquid nozzle 26.

A seal 34f may be attached to an exterior 105 of the barrel channel 19. Further, the seal 34f may engage the interior 71 of the ring nut 66. As a result, the seal 34f may secure the interior 71 of the ring nut 66 to the exterior 105 of the barrel channel 19. The diverter 78 may be inserted into the ring nut 66 such that the output end 82 of the diverter 78 may abut the first side 65 of the air cap 64. As a result, the plurality of index balls 94 of the air cap 64 may engage the plurality of recessions 88.

As illustrated in FIGS. 1, 2 and 6, a pair 94a, 94b of the plurality of index balls 94 of the air cap 64, for example, may be separated by an angle, such as, for example, one-hundred and eighty degrees. Further, the pair 94a, 94b of the plurality of index balls 94 may be offset from the diverting orifices 72a, 72b and/or diverting channels 74a, 74b, respectively, by an angle, such as, for example, twenty-two and one-half degrees.

The air cap 64 may be in an open position such that the plurality of index balls and/or the pair 94a, 94b of the plurality of index balls may engage the plurality of recessions and/or a pair 88a, 88b of the plurality of recessions 88, respectively. The pair 88a, 88b of the plurality of recessions 88 may be separated by an angle, such as, for example, one-hundred and eighty degrees. As a result, the diverter channels 74a, 74b of the air cap 64 may align with a pair 90a, 90b of the plurality of intermediate channels 90. The pair 90a, 90b of the plurality of intermediate channels 90 may be separated by an angle, such as, for example, one-hundred and eighty degrees. Moreover, air from the top channel 22 may pass from the intermediate end 92 through the pair of plurality of the intermediate channels 90 and/or through the diverter channels 74a, 74b in the open position and/or the diverter orifices 72a, 72b, respectively.

The air cap 64 may be moved to a closed position by turning the air cap clockwise or counter-clockwise. As a result the plurality of index balls 94 and/or the pair 94a, 94b of the plurality of index balls may engage adjacent pairs and/or an adjacent pair of the plurality of recessions 88, respectively. The diverter channels 74a, 74b may be in a closed position and/or may prevent air from passing through the intermediate end 92 to the diverter channels 74a, 74b. In a preferred embodiment of the present invention, the air cap 64 may have four closed positions and four open positions. Moving the air cap 64 from one of the open positions to an adjacent open position may move the diverter orifices 72a, 72b an angular distance, such as, for example, forty-five degrees.

The barrel 20 may be attached to the interior 246 of the barrel channel 19 of the spray gun 10. The input end 80 of the diverter 78 may be inserted into the interior 246 of the barrel channel 19. Further, the input end 80 may be adjacent to the barrel channel 19 and/or the top channel 22. The nozzle channels 76a, 76b of the air cap 64 and the diverter 78, respectively, may be coupled with the paint source channel 18 and/or the top channel 22. The intermediate end 92 of the diverter 78 and/or the plurality of intermediate channels 90 may be coupled with the second opening 25 of the top channel 22.

A seal 34g may be located at the input end 80 of the diverter 78 such that seal 34g may engage the interior 246 of the barrel channel 19. As a result, the seal 34g may secure the diverter 78 into the interior 246 of the barrel channel 19. Further, the seals 34a-g may be made from a material which may be resistant to deterioration from chemicals, such as, for example, TEFLON® and/or the like. Moreover, the present invention should not be deemed as limited to the embodiments of a specific material of the seals 34a-g.

As illustrated in FIGS. 1-3, the liquid needle pin 24 may be inserted to the spray gun 10. The liquid nozzle 26 may be inserted into the barrel channel 19 and/or the nozzle compartments 76a, 76b of the air cap 64 and the diverter 78, respectively. A diameter 117 of the liquid nozzle 26 may be, for example, one-thousandth ( 1/1000) or two-thousandths ( 2/1000) of an inch less than the diameter of the nozzle compartments 76a, 76b. Further, the liquid nozzle 26 may be adjacent to the opening 70 in the air cap 64 and/or may extend in an outward direction with respect to the barrel 20 through the opening 70. Moreover, the liquid nozzle 26 may be concentric with respect to the opening 70 of the air cap 64 and/or the nozzle compartments 76a, 76b of the air cap 64 and the diverter 78, respectively.

The spray gun 10 may have a housing opening 98 which may be adjacent to the paint source channel 18 and/or may be located opposite to the barrel channel 19 with respect to the paint source channel 18. The housing opening 98 may allow the liquid nozzle 26 and/or the liquid needle pin 24 to pass therein. Further, the housing opening 98 may allow the liquid nozzle 26 and/or the liquid needle pin 24 to extend into the paint source channel 18, the barrel channel 19 and/or the nozzle channels 76a, 76b of the air cap 64 and the diverter 78, respectively. The housing 32 may be inserted into the housing opening 98 such that the housing 32 may prevent, for example, air and/or paint from exiting the spray gun 10 through the housing opening 98.

The liquid needle pin 24 may extend from the bypass channel 36 through the passage 62 of the trigger 14 to the barrel channel 19 and/or the nozzle compartments 76a, 76b of the air cap 64 and the diverter 78, respectively. The two-stage air bypass valve 30 may extend outward with respect to an exterior 121 of the bypass channel 36 and/or may be located in the cavity 60 of the trigger 14. The second end 40 of the two-stage air bypass valve 30 may abut the cavity 60 of the trigger 14. The seals 34a, 34b of the two-stage air bypass valve 30 may engage an interior 127 of the bypass channel 36 and/or may secure the two-stage air bypass valve 30 into the interior 127 of the bypass channel 36. The interior 127 of the bypass channel 36 may have a fastener 56d thereon. An exterior 123 of the bypass plug 40 may have a groove 125 which may receive the fastener 56d on the interior 127 of the bypass channel 36 and/or which may lock the bypass plug 40 and/or the two-stage air bypass valve 30 into the interior 127 of the bypass channel 36. The bypass spring 44 located between the two-stage air bypass valve 30 and the bypass plug 40 may be compressed by the bypass plug 40 when the bypass plug 40 is locked into the interior 127 of the bypass channel 36. Releasing the fastener 56d of the bypass channel 36 from the groove 125 of the bypass plug 40 and/or unlocking the bypass plug 40 from the interior 127 of the bypass channel 36 may decompress the bypass spring 44. Further, the bypass plug 40 may be forced outward with respect to the bypass channel 36 by the bypass spring 44.

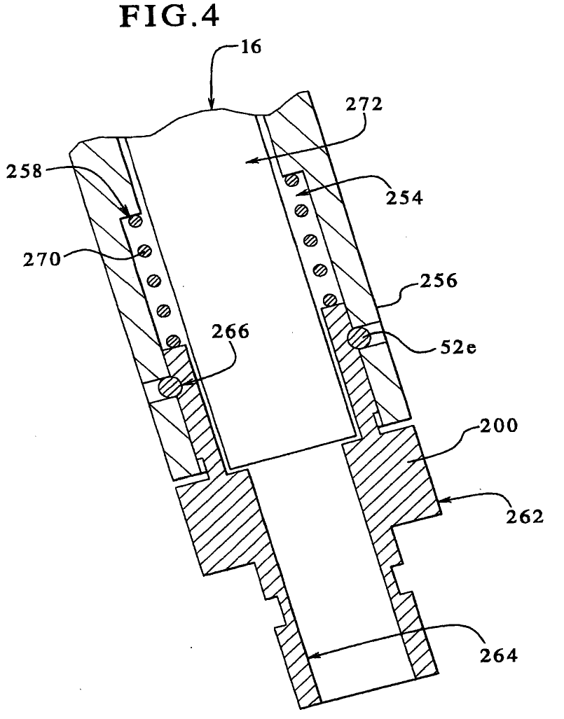

As illustrated in FIG. 4, the air source channel 16 may have an interior 254 and/or an exterior 256. The interior 254 of the air source channel 16 may have a shoulder 258 and/or a fastener 56e. The air source connector 200 may have an exterior 262 and an interior 264. The exterior 262 of the air source connector 200 may have a groove 266. Further, the fastener 56e on the interior of the air source channel 16 may engage the groove 266 on the exterior 262 of the air source connector 200. As a result, the air source connector 200 may attach to the air source channel 16. The exterior 262 of the air source connector 200 may be locked into the interior 254 of the air source channel 16.

An air source spring 270 may be located between the shoulder 258 and a first end 268 of the air source connector 200. The air source spring 270 may be compressed by the first end 268 of the air source connector 200 which may be locked into the interior 254 of the air source channel 16. Releasing the fastener 56e of the air source channel 16 from the groove 266 of the air source connector 200 and/or unlocking the air source connector 200 from the interior 254 of the air source channel 16 may decompress the air source spring 270. The first end 268 of the air source connector 200 may be forced in an outward direction with respect to the interior 254 of the air source channel 16 by air source spring 270.

The air that may enter the air source channel 16 from the air source connector 200 may have a high level of heat. An insulator 272 may be inserted into the air source channel 16. The air from the air source channel 16 may pass through the insulator 272 to the bypass channel 16. The insulator may prevent the high level of heat from being transferred to the interior 254 of the air source channel 16. Further, the insulator 272 may be a tube, for example, a hollow tube and/or may be located between the air source connector 200 and the bypass channel 36. Still further, the insulator 272 may be made from a material, such as, for example, TEFLON® and/or the like, which may be resistant to deterioration caused from chemicals.

The present invention should not be deemed as limited to the embodiments of a specific material of the insulator tube 272.

Moreover, the interior 254 and the exterior 256 of the air source channel 16, the exterior 262 and the interior 264 of the air source connector 200 and/or the insulator 272 may each have, for example, a cylindrical shape allowing for each to be connected to one another.

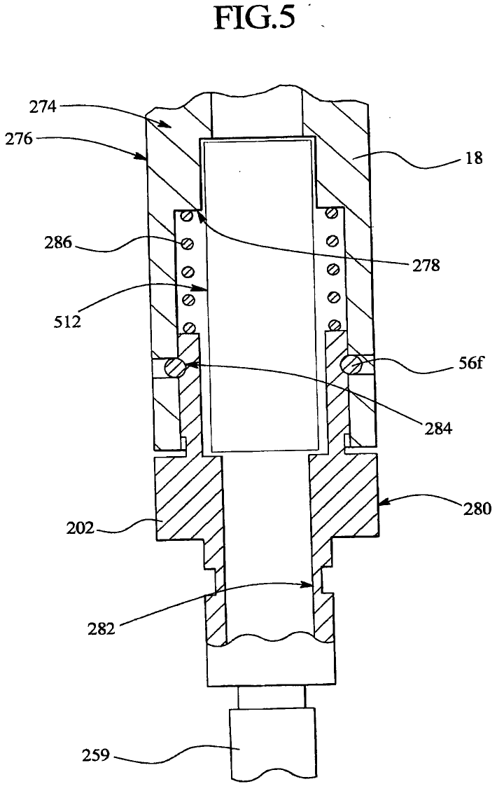

As illustrated in FIG. 5, the paint source channel 18 may have an interior 274 and/or an exterior 276. The interior 274 of the paint source channel 18 may have a shoulder 278 and/or a fastener 56f. Further, the paint source connector 202 may have an exterior 280 and/or an interior 282. The exterior 280 of the paint source 259 may have a groove 284. The fastener 56f on the interior 274 of the paint source channel 18 may engage the groove 284 on the exterior 280 of the paint source 259. As a result, the paint source 259 may attach to the paint source channel 18 and/or the exterior 280 of the paint source 259 may be locked into the interior 274 of the paint source channel 18.

A paint source spring 286 may be located between the shoulder 278 and the paint source connector 202. The paint source spring 286 may be compressed by the paint source connector 202 which may be locked into the interior 274 of the paint source channel 18. Releasing the fastener 56f of the paint source channel 18 from the groove 284 of the paint source connector 202 and/or unlocking the paint source connector 202 from the interior 274 of the paint source channel 18 may decompress the paint source spring 286. Further, the paint source connector 202 may be forced in an outward direction with 20 respect to the interior 274 of the paint source channel 18 by the paint source spring 286.

As illustrated in FIG. 1 and FIG. 5, an protective tube 512 may be inserted into the interior 276 of the paint source channel 18. The protective tube 512 may be located between the paint source connector 202 and the barrel channel 19. The paint from the paint source 259 may pass through the protective tube 512 to the liquid nozzle 26. The protective tube 512 may prevent corrosion of and/or may prevent damage to the interior 274 of the paint source channel 18. Further, the protective tube 512 may be, for example, hollow. Still further, the protective tube 512 may be made from a material, such as, for example, TEFLON® and/or the like, which may be resistant to deterioration caused from chemicals and/or paints. The present invention should not be deemed as limited to the embodiments of a specific material of the protective tube 512. Moreover, the interior 274 of the paint source channel, the interior 282 of the paint source connector 202 and/or the protective tube 512 may each have, for example, a cylindrical shape allowing for each to be connected to one another.

The trigger 14 of the spray gun 10 may have an on position and/or an off position. Further, the trigger may be in the off position and/or the bypass valve 30 may prevent the air from the air source channel 16 and/or the air source connector 200 from entering the bypass channel 36, the top channel 22, the barrel channel 19 and/or the plurality of intermediate channels 90. The control spring 45 may exert force outward with respect the bypass plug 40 which may force the second end 40 of the two-stage air bypass valve 30 outward with respect to the bypass plug 40 such that the trigger 14 may be maintained in the off position.

The trigger 14 may be engaged and/or may be moved inward with respect to the air source channel 16 such that the trigger 14 may be in the on position. Further, the trigger 14 may be in the on position and/or the second end 40 of the bypass valve 30 may be moved inward with respect to the air bypass plug 40 by the trigger 14. The control spring 45 may be compressed by the two-stage air bypass valve 30 and/or the two-stage air bypass valve 30 may be moved inward with respect the bypass plug 40.

The two-stage air bypass valve 30 may move to a location within the bypass channel 36 which may permit the air from the air source connector 200 and/or the air source channel 16 to enter the bypass channel 36 and/or the top channel 22. The chamfer 31 of the two-stage air bypass valve 30 and the surface 33 of the bypass channel 36 may be separated by the separated by engaging the trigger 14. The air from the air source connector 200 may pass between the chamfer 31 and the surface 33. Still further, the bypass nob 42 may be moved and/or may be adjusted by engaging the threading 46 between the bypass plug 40 and the bypass nob 42. As a result, the bypass knob 42 and/or the liquid needle pin 24 may move in an inward direction or an outward direction with respect to the bypass plug 40. The liquid needle pin 24 may move in an inward direction or an outward direction with respect to the liquid nozzle 26. As a result, the liquid needle pin 24 may control the amount of paint exiting the liquid nozzle 26. Movement of the liquid needle pin 24 in the inward direction or the outward direction may increase or decrease, respectively, a position at which the two-stage bypass valve 30 may engage the liquid needle pin 24. As a result, the chamfer 31 of the two-stage bypass valve 30 may be separated from the chamfer 33 of the bypass channel 36 which may permit air to pass from the air source channel 16 to the top channel 22.

The stopper 50 may abut the second opening 25 of the top channel 22. As a result, the stopper 50 may prevent the air in the top channel 22 from the air source connector 200 from entering the second opening 25 and/or the plurality of intermediate channels 90. The top channel nob 48 may be turned and/or may be adjusted via the top threading 49 connecting the top channel plug 54 to the top channel nob 48. The stopper 50 may move in an inward direction or an outward direction with respect to the top channel plug 54. Further, the stopper 50 may be withdrawn from the second opening 25 of the top channel 22 by turning and/or adjusting the top channel nob 48. The air in the top channel 22 may exit the top channel 22 through the second opening 25 of the top channel 22 and/or may enter the barrel channel 19. Still further, the top channel nob 48 may be moved and/or may be adjusted such that the stopper 50 may move in an inward direction or outward direction with respect to the top channel plug 54. The movement of the stopper 50 in the inward direction or the outward direction may increase or may decrease, respectively, the volume of air permitted to exit the second opening 25 of the top channel 22 into the plurality of intermediate channels 90.

The air may be diverted into the barrel channel 19 of the diverter 78. The air may enter the nozzle compartment 76b of the diverter 78 at the input end 80. The air may be divided into, for example, eight segments by the plurality of notches 84 of the nozzle compartments 76a, 76b and/or the indentations 222 of the liquid nozzle 26. As a result, the air may enter a channel compartment 509 of the air cap 64 and/or may exit the opening 70 of the air cap 64. The liquid needle pin 24 may be activated by the air bypass valve 30. As a result, the paint exiting an opening 510 of the liquid nozzle 26 may be atomized outside of the air cap 64 by the air exiting the opening 70 of the air cap 64. The air exiting the opening 70 and the paint exiting the opening 510 may exit the openings 70, 510 in, for example, a conically diverting spray pattern. Moreover, the volume of air permitted to exit the opening 510 of the liquid nozzle 26 by the two-stage air bypass valve 30 and the liquid needle pin 24 may effect an amount of the paint which may be atomized by the air, an amount of the atomized paint which may be exiting the opening 510, an amount of air exiting opening 70 to atomize the paint outside the air cap 64, a velocity of the atomized paint which may be atomized outside the air cap 64 and/or an air pressure of the atomized paint which may be atomized outside of the air cap 64. In the preferred embodiment of the present invention the air pressure of the paint being atomized outside the air cap 64 may not exceed, for example, ten psi and/or may be maintained at, for example, five psi, six psi or seven psi.

The air cap 64 may be in the open position and/or the air may exit the pair of intermediate channels 90 which may be aligned with the diverting channels 74a, 74b. Further, the air ay pass through the diverting channels 74a, 74b and/or may exit through the diverting orifices 72a, 72b, respectively. The angular configuration of the diverting orifices 72a, 72b may allow the air exiting the diverting orifices 72a, 72b to form air streams which may transverse each other and/or may contact the conically diverging spray pattern of the paint atomized outside the opening 70 of the air cap 64. Still further, the air streams of the diverting orifices 72a, 72b may force the conically diverging spray pattern of the atomized paint into a flat, fan-shaped spray pattern. The stopper 50 may control the volume of the air exiting the diverting orifices 72a, 72b and/or may control the effect of the air streams on the flat, fan-shaped spray pattern. Moreover, the air streams may effect an amount of flattening of the flat, fan-shaped spray pattern.

The air cap 64 may be moved to an adjacent open position which may rotate the diverting channels 74a, 74b by an angle, such as, for example forty-five degree. Moreover, the adjacent open position may align the diverting channels 74a, 74b with an adjacent pair of the intermediate channels 90 and/or may rotate the flat, fan-shaped spray pattern by an angle, such as, for example, forty-five degrees. In the preferred embodiment, the air cap 64 may have, for example, four open positions which may permit the flat fan-shaped spray pattern to be rotated a maximum of, for example, one-hundred and eighty degrees.

The spray gun 10 may receive air from the air source connector 200 via the air source channel 16 and/or the insulator 272 within the air source channel 16. The spray gun 10 may receive paint from the paint source 259 via the paint source channel 18. The spray gun 10 may have the trigger 14 which may be moved from the off position to the on position. Further, the trigger may be in an on position which may move the two-stage air bypass valve 30 to permit the air to flow through the bypass channel 36, the top channel 22, the barrel channel 19, the nozzle compartments 76a, 76b, the plurality of the intermediate channels 90 and/or out the opening 70 of the air cap 64. The air in the nozzle channel 19 may atomize the paint from the paint source channel 18 and/or force the paint through the nozzle compartments 76a, 76b of the air cap 64 and the diverter 78, respectively, and/or out the opening 70 of the air cap 64 in a conically diverging spray pattern. Still further, the air cap may be in the open position allowing air from the pair of intermediate channels 90 which may be aligned with the diverting channels 74a, 74b to pass through the diverting channels 74a, 74b and/or out the diverting orifices 72a, 72b respectively. Moreover, the air streams exiting the diverting orifices 72a, 72b of the air cap 64 may force the conically diverging spray pattern of the atomized paint into a flat fan-shaped spray pattern.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

1. A spray gun receiving air from an air source and paint from a paint source, the spray gun comprising:
a first channel having a first end and a second end opposite to the first end wherein the first channel connects to the air source and further wherein a valve abuts the first end of the first channel;
a top channel having a first end and a second end opposite to the first end wherein the top channel is connected to the interior of the first channel and the paint source and further wherein the second end of the top channel is adjacent to the first channel;
a nozzle having a passage defined between a first end and a second end wherein the passage connects to the first end of the top channel and the paint source wherein the second end of the nozzle is adjacent to the first end of the top channel; and
a first spring between the valve and the second end of the first channel.

2. The spray gun of claim 1 further comprising:
a second spring between the first end of the top channel and the second end of the top channel.

3. The spray gun of claim 1 further comprising:
a second spring between the first channel and the air source.

4. The spray gun of claim 1 further comprising:
a second spring between the top channel and the paint source.

5. The spray gun of claim 1 further comprising:
a ball in the first channel.

6. The spray gun of claim 1 further comprising:
a ball in the top channel.

7. The spray gun of claim 1 further comprising:
a ball between the first channel and the air source.

8. The spray gun of claim 1 further comprising:
a ball between the top channel and the paint source.

9. The spray gun of claim 1 further comprising:
a ball between the top channel and the nozzle.

10. The spray gun of claim 1 further comprising:
a tube between the air source and the first channel wherein the air from the air source passes through the tube into the first channel.

11. The spray gun of claim 1 further comprising:
a groove in the top channel wherein the groove is located between the first end and the second end of the top channel.

12. The spray gun of claim 1 further comprising:
a plurality of recessions between the first end and the second end of the nozzle.

13. A spray gun receiving air from an air source and paint from a paint source, the spray gun comprising:
a barrel having a nozzle, a diverter and a cap connected to the diverter by a nut wherein the nozzle extends through the diverter and the cap and further wherein the nozzle is connected to the paint source;
a plurality of recessions on the diverter wherein the cap is adjacent to the plurality of recessions;
a plurality of channels connecting the air source to the barrel wherein each of the plurality of channels have an interior and an exterior wherein the diverter of the barrel attaches to the plurality of channels and further wherein the air from the air source moves through the interior of each of the plurality of channels to the barrel; and
a plurality of seals located between the interior and the exterior of each of the plurality of channels and further wherein each of the plurality of seals prevents the air in the interior of each of the plurality of channels from escaping to the exterior of each of the plurality of channels.

14. The spray gun of claim 13 wherein the plurality of seals are chemically resistant.

15. The spray gun of claim 13 wherein the plurality of seals are flourocarbon resins.

16. The spray gun of claim 13 wherein each of the plurality of seals are adjacent to a corresponding one of each of the plurality of channels.

17. A method for assembling a spray gun coupled with a spring-loaded air diverter, the method comprising the steps of:
providing a spray gun having a first channel, a second channel connected to the first channel and a trigger wherein the second channel has a passage defined between a first end and a second end;
providing a diverter having a first end and a second end opposite to the first end wherein the diverter has an opening and a plurality of recessions around the opening wherein the opening extends through the diverter from the first end to the second end and further wherein the diverter has a first groove located between the first end and the second end;
attaching an engaging element to the second channel wherein the engaging element is adjacent to the second end of the second channel;
inserting the diverter into the second channel wherein the first groove of the diverter receives the engaging element of the second channel; and
attaching a cover to the second channel wherein the cover has an exterior and an interior wherein the cover encloses the diverter in the second channel and further wherein the cover has a second groove receiving the engaging element of the second channel.

18. The method of 17 further comprising the step of:
attaching a nut between the cover and the second channel.

19. The method of 17 wherein the second groove extends through the cover from the exterior to the interior.

20. The method of claim 17 wherein the engaging element is a ball.

21. The method of claim 17 further comprising the step of:
inserting a spring into the second channel.

22. The method of claim 17 further comprising the step of:
inserting a spring into the first channel.

23. The method of claim 17 further comprising the step of:
providing a ring between the cover and the diverter.

24. The method of claim 17 wherein the engaging element is a pin.

25. The method of claim 17 wherein the second groove is covered by the exterior of the cover.

26. A barrel for a spray gun, the barrel comprising:
a channel having a first side and a second side opposite to the first side wherein the channel has an exterior and an interior;
a diverter having a first end and a second end opposite to the first end wherein the diverter has a compartment defined by a perimeter wherein the compartment is centered within a plurality of channels wherein the compartment and the plurality of channels extend through the diverter from the first end to the second end;
a cap having a front side and a back side wherein the cap has an orifice and channels wherein the orifice and the channels extend through the cap from the front side to the back side and further wherein the orifice is between the channels;
a nut having first side and a second side opposite the first side wherein the nut has an exterior and an interior wherein the nut connects the back side of the cap to the first side of the diverter wherein the second side of the diverter is adjacent to the second side of the nut and further wherein the nut has a first groove adjacent to the second side; and
an engaging element extending from the exterior of the channel to the interior of the channel wherein the engaging element is adjacent to the second side of the channel and further wherein the first groove of the nut receives the engaging element wherein the nut is connected to the channel.

27. The barrel of claim 26 further comprising:
a spring between the first end of the diverter and the first side of the channel.

28. The barrel of claim 26 wherein the groove extends through the nut from the exterior of the nut to the interior of the nut.

29. The barrel of claim 26 wherein the groove is adjacent to the interior of the nut.

30. The barrel of claim 26 wherein the engaging element is a ball.

31. The barrel of claim 26 wherein the engaging element is a pin.

32. The barrel of claim 26 further comprising:
a ring between the back side of the cap and the first side of the diverter.

33. The barrel of claim 26 further comprising:
a plurality of recessions located on the first end of the diverter.

34. The barrel of claim 26 further comprising:
a plurality of balls on the back side of the cap.

35. The barrel of claim 26 wherein the engaging element of the channel connects the diverter to the channel.

36. The barrel of claim 26 further comprising:
a second groove adjacent to the first end of the diverter.
